(19) United States
(12) Patent Application Publication
(10) Pub. No.: US 2008/0085036 A1
(43) Pub. Date: Apr. 10, 2008

(54) Image search apparatus, method of controlling same and control program therefor

(75) Inventor: Kazuhito Fukushi, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 11/902,482

(22) Filed: Sep. 21, 2007

(30) Foreign Application Priority Data
Sep. 22, 2006 (JP) 2006-256557

(51) Int. Cl. G06K 9/00

(52) U.S. Cl. 382/118

(57) ABSTRACT

Starting from the image of a person that was shot at a certain time, images of the person that were shot in the past or future of the certain time are found. A number of frames of search-target images are grouped in the order of the years in which they were shot. An image that was shot at a certain time is specified as an initial search-source image. From within the group to which the specified search-source image belongs, a search-target image containing a face image that resembles a face image contained in the specified search-source image is found. By using the found search-target image as a new search-source image, an image containing a face image that resembles the face image contained in the new search-source image is found from among search-target images that belong to the group of the preceding (or following) year. Present or past images of the person are found while the search-source image that serves as an object the comparison for finding images is updated.

### BACKGROUND OF THE INVENTION

1. Field of the Invention

This invention relates to an image search apparatus, a method of controlling this apparatus and a program for the same.

2. Description of the Related Art

Consideration has been given to finding the image of a desired person from among a number of image frames. There are instances where the image of a face is utilized in order to find the image of a desired person. For example, there is a technique in which a dictionary for image recognition is updated automatically by following up changes in personal needs (see the specification of Japanese Patent Application Laid-Open No. 9-35068); a technique in which even if a face at the time of registration and a face at the time of authentication differ, the same or similar face image can be extracted (see the specification of Japanese Patent Application Laid-Open No. 2005-352554); a technique whereby a face image is updated in such a manner that it is always the latest image (see the specification of Japanese Patent Application Laid-Open No. 2005-84991); a technique that makes authentication possible even if there is a change in environment such as humidity (see the specification of Japanese Patent Application Laid-Open No. 2002-236665); a technique whereby it is possible to safely update personal information for discrimination purposes (see the specification of Japanese Patent Application Laid-Open No. 2003-16451); and a technique for updating comparison data utilizing data discriminated as being that of the person himself (see the specification of Japanese Patent Application Laid-Open No. 2003-44858).

However, no consideration has been given to finding the image of a specific person in the past as seen from a certain time point in time or in the future as seen from a certain point in time.

### SUMMARY OF THE INVENTION

Accordingly, an object of the present invention is to find the image of a specific person in the past as seen from a certain time point in time or in the future as seen from a certain point in time.

According to the present invention, the foregoing object is attained by providing an image search apparatus comprising: a grouping device for grouping a number of frames of search-target images in accordance with shooting dates; a similar-image detecting device for detecting a search-target image from among search-target images that belong to a group containing search-target images that were shot on a shooting date close to the shooting date of a search-source image that includes a reference face image (the face image of a person desired to be found), wherein the group is among groups obtained by grouping by the grouping device and the search-target image detected contains a face image similar to the reference face image included in the search-source image; a similar-image detection control device for controlling the similar-image detecting device so as to perform the detection processing using the search-target image, which has been detected by the similar-image detecting device, as a new search-source image; and a control device for controlling the similar-image detecting device and the similar-image detection control device so as to repeat the detection processing and control processing.

The present invention also provides a method suited to the above-described image search apparatus. Specifically, there is provided a method of controlling an image search apparatus, comprising the steps of: grouping, by a grouping device, a number of frames of search-target images in accordance with shooting dates; detecting, by a similar-image detecting device, a search-target image from among search-target images that belong to a group containing search-target images that were shot on a shooting date close to the shooting date of a search-source image that includes a reference face image, wherein the group is among groups obtained by grouping by the grouping device and the search-target image detected contains a face image similar to the reference face image included in the search-source image; controlling, by a similar-image detection control device, the similar-image detecting device so as to perform the detection processing using the search-target image, which has been detected by the similar-image detecting device, as a new search-source image; and controlling, by a control device, the similar-image detecting device and the similar-image detection control device so as to repeat the detection processing and control processing.

The present invention also provides a program for implementing the method of controlling the image search apparatus described above, as well as a recording medium on which this program has been stored.

In accordance with the present invention, a number of frames of search-target images (images that are the object of a search) are grouped in accordance with shooting dates. A search-target image containing a face image resembling a face image that will serve as a reference (the face image of a person to be found) is detected from among search-target images that belong to a group containing search-target images that were shot on a shooting date close to the shooting date of a search-source image (an image serving as a key image that is the object of comparison) that includes the reference face image. (The “close shooting date” in one in the near future or near past as seen from the shooting date of the search-source image.) By adopting the detected search-target image as a new search-source image, a search-target image containing a face image that resembles the face image (the new reference face image) contained in the new search-source image is detected from among search-target images that belong to a group containing search-target images that were shot on a shooting date that is the next closest shooting date.

Thus, in dependence upon whether a search-target image, which is the object of a search, lies in the past or future of a certain time, the search-source image also is updated in order in accordance with the time series of the images. As a result, starting from a face image that serves as a reference, face images from the past can be detected in reverse chronological order (e.g., by using the image of an adult, childhood images of this person can be detected) and face images lying in the future of the reference face image can be detected (e.g., by using an image from childhood, images of the person after the person has become and adult can be detected).

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of an image search apparatus;

FIGS. 2 and 3 are flowcharts illustrating processing executed by the image search apparatus;

FIG. 4 illustrates the manner in which search-target images are grouped;

FIG. 5 illustrates a list of features;

FIG. 6 illustrates a list of similar images; and

FIGS. 7A to 7D illustrate the manner in which a search-source image is updated.

### DESCRIPTION OF THE PREFERRED EMBODIMENT

A preferred embodiment of the present invention will now be described in detail with reference to the drawings.

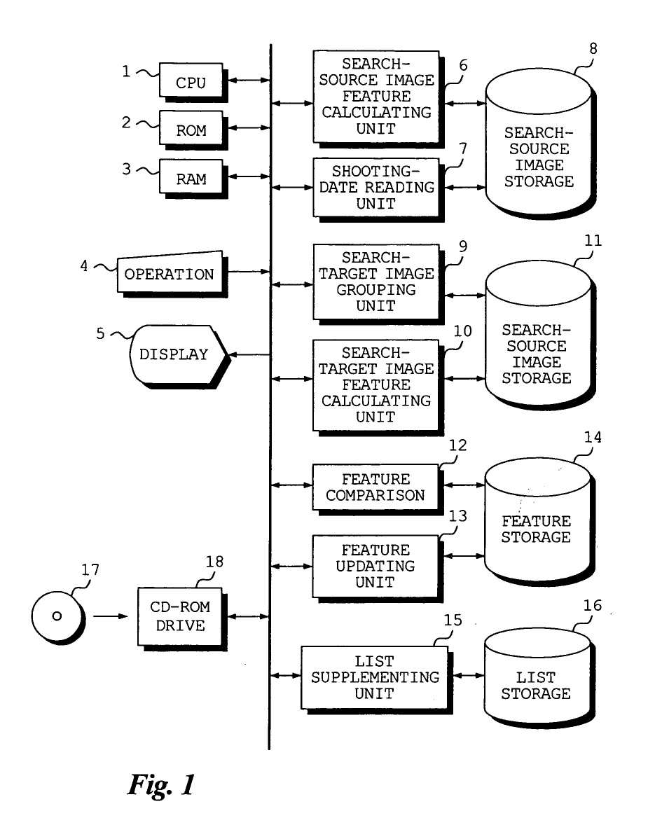

FIG. 1 is a block diagram illustrating the electrical configuration of an image search apparatus according to an embodiment of the present invention. Using an image that was shot at a certain time, the image search apparatus according to this embodiment detects face images in the past and face images in the future as seen from the certain point in time. Images from the childhood of a person can be found using an image of the person after the person has become an adult, and images of a person after the person has become an adult can be found using a childhood image of the person.

The operation of the overall image search apparatus is controlled by a CPU 1.

The image search apparatus includes a CD-ROM (Compact Disk—Read-Only Memory) drive 18. A CD-ROM 17 contains the operating program of the image search apparatus. By loading the CD-ROM 17 into the CD-ROM drive 18, the operating program is read and installed in the image search apparatus. As a result, the image search apparatus operates as described below.

The image search apparatus further includes a ROM 2 on which the necessary data has been stored in advance; a RAM 3 for storing data temporarily; an operating unit 4 for inputting commands from the user; and a display unit 5 for displaying images obtained by a search.

The image search apparatus further includes a search-source image storage device 8 for storing an image representing a search-source image serving as a basis for comparison with a person (face) to be detected. Features are calculated by a search-source image feature calculating unit 6. The features represent the degree of face likeliness of a face image (a value indicating the degree to which an image portion discriminated as being a face image is face-like) contained in a search-source image represented by an search-source image file stored in the search-source image storage device 8, and the degree of person resemblance of the face image (a value indicating the degree of a match with the person to be detected). Further, the shooting date of the search-source image is read by a shooting-date reading unit 7. It goes without saying that the shooting date of the search-source image has been recorded on the search-source image.

The image search apparatus further includes a search-target image storage device 11 for storing image files representing a number of frames of search-target images that constitute the objects of a search. Image files that have been stored in the search-target image storage device 11 are grouped by a grouping unit 9 based upon shooting dates, as will be described later. Features representing the degree of face likeliness and degree of person resemblance are calculated by a search-target image feature calculating unit 10. (As mentioned above, the degree of person resemblance is a value indicating the degree of a match with the face image of a person specified by a face image contained in a search-destination image.)

The image search apparatus further includes a feature storage device 14. Features that have been stored in the feature storage device 14 are features for the purpose of comparison, as will be described later, and are compared by a feature comparison unit 12. Features that have been stored in the feature storage device 14 are updated by a feature updating unit 13.

The image search apparatus further includes a storage device 16 for storing a list of similar images. File names of image files (and the image files per se, if desired) representing search-target images that seem to be similar to a search-source image have been stored in the list storage device 16. File names are added to the list storage device 16 by a list supplementing unit 15.

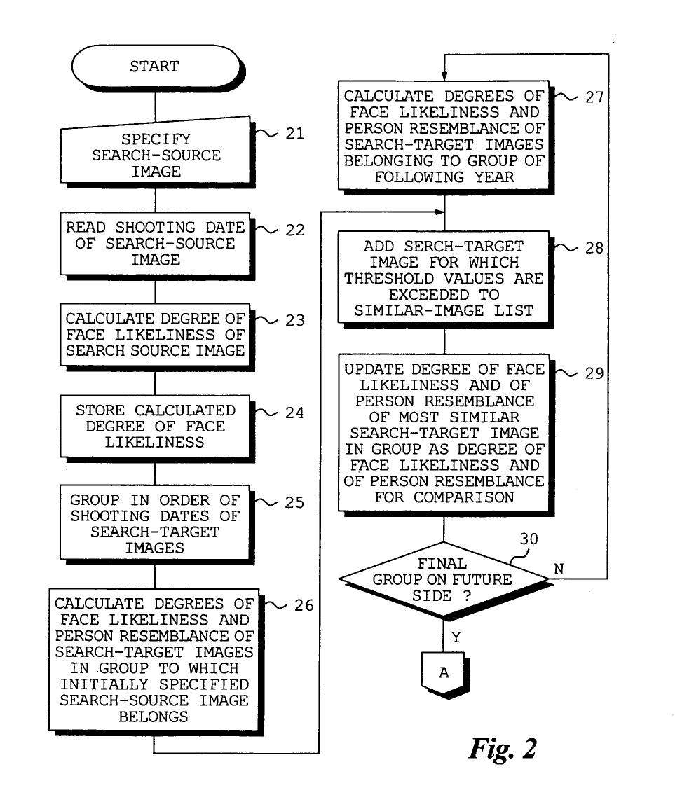

FIGS. 2 and 3 are flowcharts illustrating the processing executed by the image search apparatus.

A number of search-target image files have been stored in the search-target image storage device 11, as mentioned above. These search-target image files are read. An image that contains the face image of a person that is to be found is specified from among the number of frames of search-target images represented by the search-target image files that have been read (step 21). This specified search-target image becomes the initial search-source image. Of course, it may be so arranged that the search-source image is selected not from among search-target images but from among image files that have been stored in another image database or the like. The search-source image is stored in the search-source image storage device 8. The date on which the search-source image was shot is read by the shooting-date reading unit 7 (step 22). Next, a face image is detected from within the search-source image and the degree of face likeliness of the detected face image is calculated (step 23). If the search-source image contains a plurality of face images, the desired face image would be designated by the user. The calculated degree of face likeliness is stored in the feature storage device 14 as a feature of the search-destination image (step 24). Next, the search-target image files that have been stored in the search-target image storage device 11 are grouped according to the years in which they were shot (step 25). The search-target image files need not necessarily be grouped according to year and may be grouped by month or week in which they were shot.

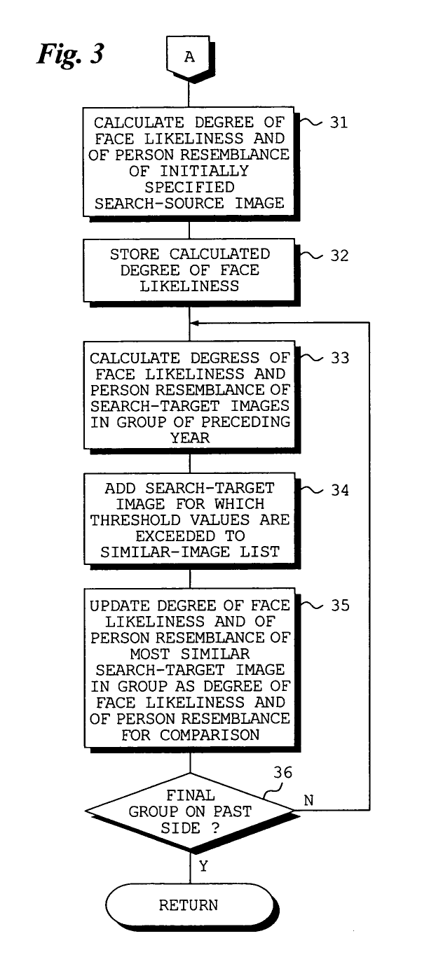

FIG. 4 illustrates the manner in which search-target images have been grouped according to the years in which they were shot. It will be assumed that an image that was shot in 1996 (file name 0123.JPG) has been specified as a search-source image.

In this case, images that were shot in 1996 constitute a reference group Gr0 (1996). The numerals enclosed in parentheses indicate the year in which the search-target images belonging to the group were shot. Only images shot in 1996 belong to the group Gr0 (1996). The same holds true for other groups. Groups from Gr(−1) (1995) to Gr(−m) (1990) to which belong images that were shot earlier than the search-target images belonging to the reference group Gr0 (1996) constitute groups on the past side of 1996. Groups from Gr(+1) (1997) to Gr(+n) (2006) to which belong images that were shot later than the search-target images belonging to the reference group Gr0 (1996) constitute groups on the future side of 1996.

From within the group Gr0 (1996) to which the specified search-source image 0123.JPG belongs, a search-target image 0101.JPG containing a face image f01 that resembles a face image f00 contained in the specified search-source image 0123.JPG is found. The search-target image 0101.JPG that has been found becomes a new search-source image 0101.JPG, and a search-target image 0096.JPG (or 0156.JPG) containing a face image f(−1) [or f(+1)] that resembles the face image f01 contained in this search-source image 0101.JPG is found from within group Gr(−1) (1995) [or Gr(+1) (1997)] that was shot in the preceding (or following) year. The search-target image 0096.JPG (or 0156.JPG) that has been found becomes a new search-source image, and a search-target image is found from within group Gr(−2) (1994) [or Gr(+2) (1998)] shot a further one year earlier (or later). Since the search-target image that is the object of comparison utilized in order to find images is updated so as to become an image of the preceding (or following) year serving as a search target in which images are to be found, the change from one face image to the next is small. Face images of the same person can be found going back in time. Accordingly, by using an image containing a face image of a person after the person has become an adult, it is possible to find images containing face images from the childhood of the person. Further, since face images of the same person can be found going forward into the future, it is possible to find images containing face images of the person in adulthood.

With reference again to FIG. 2, the search-target image feature calculating unit 10 calculates the degrees of face likeliness and degrees of person resemblance of the search-target images in the group to which the initially specified search-source image belongs (step 26). The initially specified search-source image is the image of file name 0123.JPG belonging to group Gr0 (1996). Accordingly, the feature that is the degree of person resemblance is calculated by comparing the face-image portion f00 contained in the search-source image of file name 0123.JPG and the face-image portions contained in the other search-destination images belonging to group Gr0 (1996).

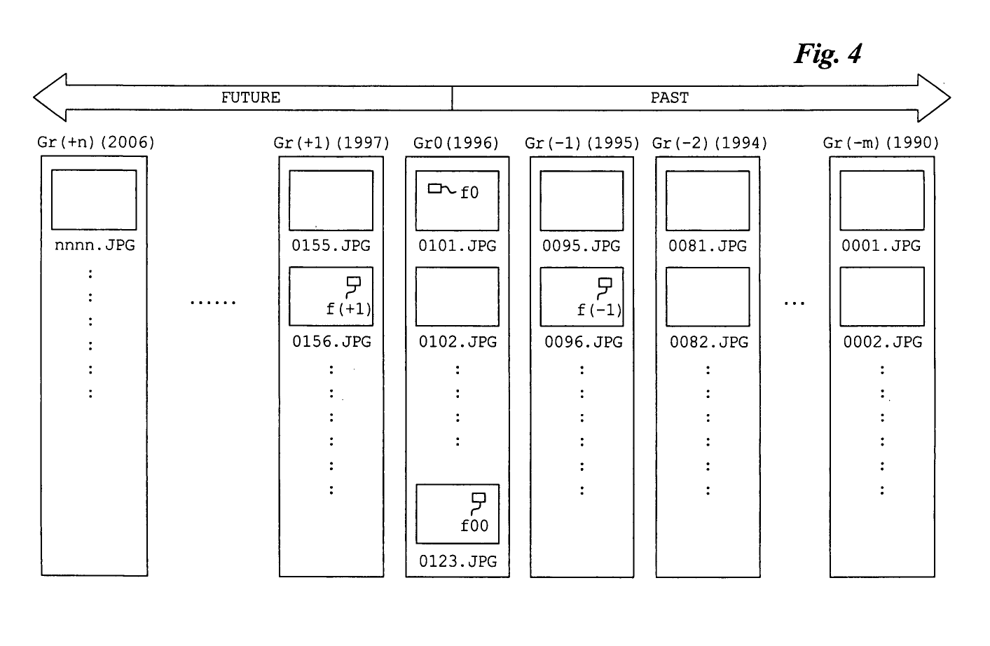

FIG. 5 illustrates an example of a feature list indicating calculated values of degrees of face likeliness and degrees of person resemblance. This list pertains to group Gr0 (1996).

The values of degrees of face likeliness and degrees of person resemblance are stored in the feature list in correspondence with the file names of the search-target images belonging to group Gr0 (1996). The feature list is stored in the feature storage device 14. The larger the value of face likeliness, the more face-like the face-image portion contained in the search-target image. The larger the value of person resemblance, the more the face-image portion contained in the search-target image resembles the face image contained in the search-source image with which the comparison is made. The more a search-target image has large values for both face likeliness and person resemblance, the more it is construed to be similar to the search-source image and the more the face image in the search-source image and the face image in the search-target image are judged to be of the same person.

With reference again to FIG. 2, the file name for which the values of degree of face likeliness and degree of person resemblance exceed threshold values is added to the list of similar images using the list supplementing unit 15 (step 28).

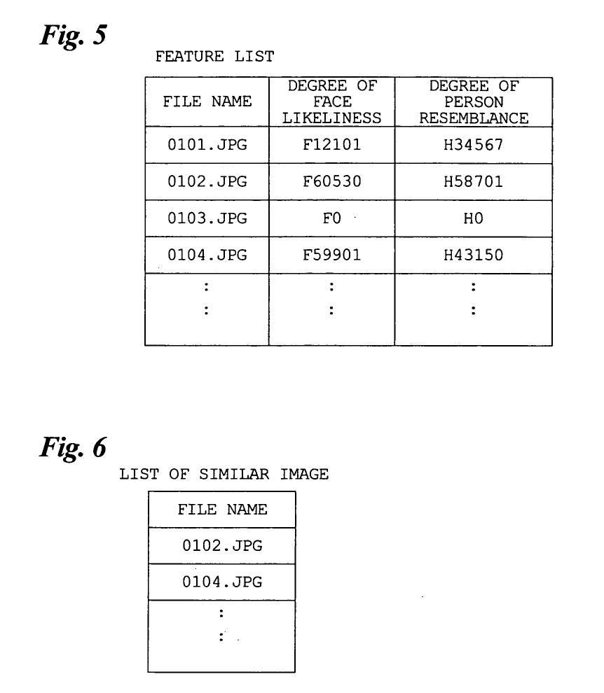

FIG. 6 illustrates an example of a list of similar images group Gr0 (1996). File names such as file name 0102.JPG of an image having a degree of face likeliness and degree of person resemblance whose values exceed threshold values have been stored in the list of similar images.

With reference to FIG. 2, the degree of face likeliness and degree of person resemblance of the search-target image having the face image that most resembles the face image contained in the search-source image within the group are stored in the feature storage device 14 as degree of face likeliness and degree of person resemblance for the purpose of comparison, thereby updating the stored content of the storage device (step 29). For example, assume that the search-source image initially specified by the user is the image of file name 0123.JPG shot in 1996, and that the search-target image that contains a face image having the largest values of face likeliness and person resemblance is the image having the file name 0101.JPG among the search-target images shot in 1996. On the basis of this assumption, the features of face likeliness and person resemblance corresponding to the file name 0101.JPG are stored in the feature storage device 14.

If the group for which face likeliness, etc., has been calculated is not the last group on the future side (“NO” at step 30), then the values of degrees of face likeliness and person resemblance of the search-target images belonging to group Gr(+1) (1997) of the following year are calculated (step 27). Here the degree of person resemblance is calculated using the search-source image updated in the manner described above and not the initially specified search-source image. This is followed by executing step 28, at which the search-target image for which the threshold values are exceeded is added to the list of similar images, and step 29, namely the updating of the degrees of face likeliness and person resemblance regarding the image containing the face image that most resembles the face image contained in the search-source image that has been updated. The processing of steps 27 to 29 is repeated up to the last group Gr(+n) (2006) on the future side.

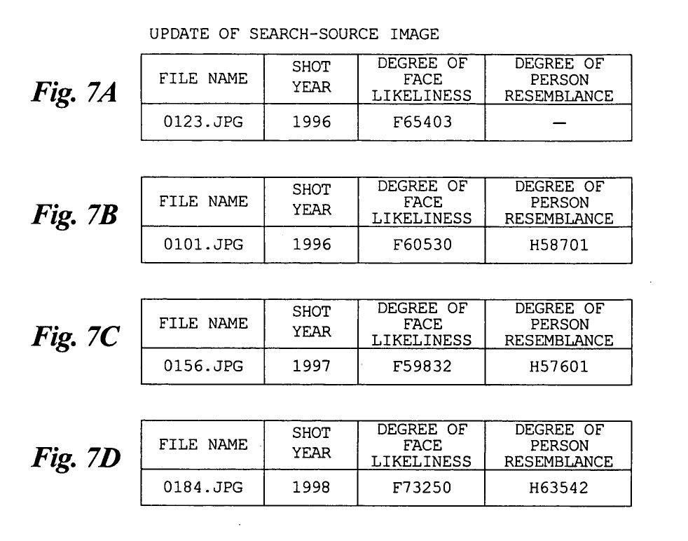

FIGS. 7A to 7D illustrate the manner in which a search-source image is updated.

As shown in FIG. 7A, the search-source image initially specified by the user is that of file name 0123.JPG and was shot in 1996. Updating is performed in such a manner that from among the search-source images shot in the same year as that of this initially specified search-source image (file name 0123.JPG), the search-destination image (file name 0101.JPG) containing a face image that resembles (that has large values of degree of face likeliness and person resemblance) the face image contained in the initially specified search-source image (file name 0123.JPG) becomes the new search-source image (see FIG. 7B). A search-target image (file name 0156.JPG) containing a face image that resembles the face image contained in the updated search-source image (file name 0101.JPG) is detected from within the group shot in the following year, namely 1997. The detected search-target image (file name 0156.JPG) is updated as the new search-source image (see FIG. 7C). Similarly, a search-target image (file name 0184.JPG) containing a face image that resembles the face image contained in the updated search-source image (file name 0156.JPG) is detected from within the group shot in the following year, namely 1998. The detected search-target image (file name 0184.JPG) is updated as the new search-source image (see FIG. 7D).

Thus, by using a search-source image from the preceding year, a search-target image from the following year is searched and retrieved. This means that even if an image containing a face image from a person's childhood has been specified as the initial search-source image, images containing face images of the person after the person has become an adult can be found.

With reference again to FIG. 2, if it is determined that the group is the last group on the future side (“YES” at step 30), then a search is conducted with regard to search-target images that are in the past relative to the year in which the initially specified search-source image was shot. To accomplish this, the degree of face likeliness of the initially specified search-source image is calculated again (step 31 in FIG. 3). The calculated degree of face likeliness is stored (step 32).

The degrees of face likeliness and degrees of person resemblance of the search-target images in the group Gr(−1) (1995) to which belong search-source images shot in the year preceding the year in which the initially specified search-source image was shot are calculated (step 33) and the search-target image for which the threshold values are exceeded is added to the list of similar images (step 34). The degree of face likeliness and degree of person resemblance of the search-target image containing the closest resembling face image in this group are updated as the degrees of face likeliness and person resemblance for the purpose of comparison (step 35). The processing of steps 33 to 35 is repeated while going backward in time to groups shot in preceding years in a manner similar to that of processing on the future side (step 36).

Thus, even if the initially specified search-source image contains a face image of a person after the person has become an adult, images containing face images from the person's childhood can be found.

In the embodiment described above, the processing on the past side is executed after the processing on the future side. However, this may be reversed or alternated. Furthermore, although processing is repeated up to the final group on the future side or past side in the above embodiment, processing may be terminated several years before or after the year in which the initially specified search-source image was shot. Furthermore, since human growth takes place largely during childhood, a change in the face image is drastic during this period. Therefore, in a case where childhood images are searched, it may be so arranged that the time periods into which images are grouped are shortened. In such case the processing executed would include inputting the age of the person in the image of a person (face image) contained in an image, determining a childhood image based upon the input age and the year in which the image was shot, and shortening the grouping time period in the case of a childhood image.

As many apparently widely different embodiments of the present invention can be made without departing from the spirit and scope thereof, it is to be understood that the invention is not limited to the specific embodiments thereof except as defined in the appended claims.

What is claimed is:

1. An image search apparatus comprising:
a grouping device for grouping a number of frames of search-target images in accordance with shooting dates;
a similar-image detecting device for detecting a search-target image from among search-target images that belong to a group containing search-target images that were shot on a shooting date close to the shooting date of a search-source image that includes a face image that will serve as a reference, wherein the group is among groups obtained by grouping by said grouping device and the search-target image detected contains a face image similar to the reference face image included in the search-source image;
a similar-image detection control device for controlling said similar-image detecting device so as to perform the detection processing using the search-target image, which has been detected by said similar-image detecting device, as a new search-source image; and
a control device for controlling said similar-image detecting device and said similar-image detection control device so as to repeat the detection processing and the control processing.

2. A method of controlling an image search apparatus, comprising the steps of:
grouping, by a grouping device, a number of frames of search-target images in accordance with shooting dates;
detecting, by a similar-image detecting device, a search-target image from among search-target images that belong to a group containing search-target images that were shot on a shooting date close to the shooting date of a search-source image that includes a face image that will serve as a reference, wherein the group is among groups obtained by grouping by said grouping device and the search-target image detected contains a face image similar to the reference face image included in the search-source image;
controlling, by a similar-image detection control device, the similar-image detecting device so as to perform the detection processing using the search-target image, which has been detected by said similar-image detecting device, as a new search-source image; and
controlling, by a control device, said similar-image detecting device and the similar-image detection control device so as to repeat the detection processing and the control processing.

3. A program for controlling an image search apparatus, the program comprising the steps of:
grouping a number of frames of search-target images in accordance with shooting dates;
detecting a search-target image from among search-target images that belong to a group containing search-target images that were shot on a shooting date close to the shooting date of a search-source image that includes a face image that will serve as a reference, wherein the group is among groups obtained by grouping and the search-target image detected contains a face image similar to the reference face image included in the search-source image;
perform the detection processing using the detected search-target image as a new search-source image; and
repeating the detection processing and the control processing.

4. A recording medium storing the program set forth in claim 3.
